(19) United States
(12) Patent Application Publication
(10) Pub. No.: US 2005/0046753 A1
(43) Pub. Date: Mar. 3, 2005

(54) Four-color CRT projection method and apparatus

(75) Inventor: Han-tak Kwak, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/924,826

(22) Filed: Aug. 25, 2004

(30) Foreign Application Priority Data
Aug. 25, 2003 (KR) 03-58888

(51) Int. Cl. H04N 9/31

(52) U.S. Cl. 348/745; 348/744

(57) ABSTRACT

An image projection method and an apparatus including red, green, blue, and white color cathode ray tubes (CRTs). The projection apparatus includes a digital-analog converter receiving one or more digital image signals from an image source and converting the digital signals into analog signals; one or more cathode ray tubes receiving the analog signals and outputting optical beams having strengths corresponding to the signals; a screen, a point on which the optical beams are concentrated to form a pixel; and a convergence module receiving an image synchronization signal and a convergence control signal from the image source and providing the signals to the cathode ray tubes so that the optical beams can be concentrated on the point. The digital image signals include a white color image signal, and the cathode ray tubes include a white color cathode ray tube receiving the white color image signal and outputting a white color optical beam corresponding to the signal. Therefore, high brightness and clear contrast can be obtained even when a cathode ray tube with a small aperture is used.

### BACKGROUND OF THE INVENTION

This application claims the priority of Korean Patent Application No. 2003-58888, filed on Aug. 25, 2003, in the Korean Intellectual Property Office, the disclosure of which is incorporated herein in its entirety by reference.

1. Field of the Invention

The present invention relates to a cathode ray tube (CRT) projection method and an apparatus, and more particularly, to a projection method and an apparatus including four CRTs, that is, red, green, blue, and white, color CRTs.

2. Description of the Related Art

An image projection system is a system for projecting an image signal onto a screen through a 3-tube or single tube projector. Here, the image signal may hold information on an RGB color system or a YUV color system. If the image signal holds information on the RGB color system, image information included in one pixel is represented as a signal having ratios of red, green, and blue colors, and the signal is converted into a physical signal by the projector to be projected onto one point of the screen. A cathode ray tube (CRT) is widely used as the projector. Each of the beams projected onto the point on the screen are combined optically and represented as one color, and then, represents color information forming the brightness and color.

FIG. 1 is a view showing a projection device using a conventional 3-tube CRT.

Image information, which will be projected as one pixel, is divided into R, G, and B signals 131, 132, and 133 and input into a digital-analog converter 130. Here, information on the R, G, and B signals 131, 132, and 133 represents levels of colors, red, green, and blue colors, included in one pixel. Various input devices can be used as an image source, which outputs the information on R, G, and B colors, and the input device may be a device outputting a digital image signal, a device such as a personal computer, a notebook computer, and a personal digital assistant (PDA).

The R, G, and B signals 121, 122, and 123, which were converted into analog signals, are input into CRTs 111, 112, and 113. The CRTs 111, 112, and 113 convert each R, G, and B value input respectively as R, G, and B signals into optical beams 101, 102, and 103, having strength corresponding to the R, G, and B signals. Each of the optical beams 101, 102, and 103 having a predetermined strengths is projected onto one point on the screen 100. Each of the CRTs 111, 112, and 113 receives convergence control information 141 from a convergence module 140 so that the three optical beams 101, 102, and 103 can be projected onto one point of the screen 100. The convergence module 140 receives position information of a point on which R, G, and B information is projected by the image source and information on synchronization 142 to form the convergence control information 141.

In the projection system using the conventional 3-tube CRT, the image information included in one pixel can only be represented by combining the values of R, G, and B components, and consequently, a physical amount that can be optically represented is limited. If it is assumed that a range of an R, G, or B optical beam value is between 0 and 100 in the projection system having a CRT of a predetermined aperture, information included in one pixel is the value formed by combining each of the R, G, and B components ((0,0,0) through (100,100,100)) since each of the components is of a value from 0 to 100. That is, the brightness and contrast of one pixel are limited. Also, there is a method of increasing the aperture of the CRT for solving the limitation of brightness and contrast, however, increasing the aperture causes problems of overheating and increased costs.

### SUMMARY OF THE INVENTION

The present invention provides a projection device and a projection method, by which high brightness and clear contrast can be obtained even if a cathode ray tube (CRT) having a small aperture is used.

According to an aspect of the present invention, there is provided an image projection apparatus including: a digital-analog converter receiving one or more digital image signals from an image source and converting the digital signals into analog signals; one or more CRTs receiving the analog converted signals and outputting optical beams having strengths corresponding to the analog signals; a screen on which the optical beams are concentrated on one point to form a pixel; and a convergence module receiving an image synchronization signal and a convergence control signal from the image source and providing the signals to the CRTs so that the optical beams can be concentrated on one point. The digital image signals include a white color image signal, and the CRTs include a white color CRT receiving the white color image signal and outputting a white color optical beam corresponding to the signal.

According to another aspect of the present invention, there is provided an image projection method including: receiving one or more digital signals from an image source and converting the signals into analog signals; receiving the analog signals and outputting optical beams having strengths corresponding to the analog signals; and receiving an image synchronization signal and a convergence control signal from the image source and providing the received signals to a CRT so that the optical beams can be concentrated on one point. The digital image signals include a white color image signal, and outputting the optical beams includes receiving the white color image signal and outputting a white color optical beam corresponding to the signal.

### BRIEF DESCRIPTION OF THE DRAWINGS

The above and other features and advantages of the present invention will become more apparent by describing in detail exemplary embodiments thereof with reference to the attached drawings in which:

FIG. 1 is a view of a projection device using a conventional 3-tube cathode ray tube (CRT);

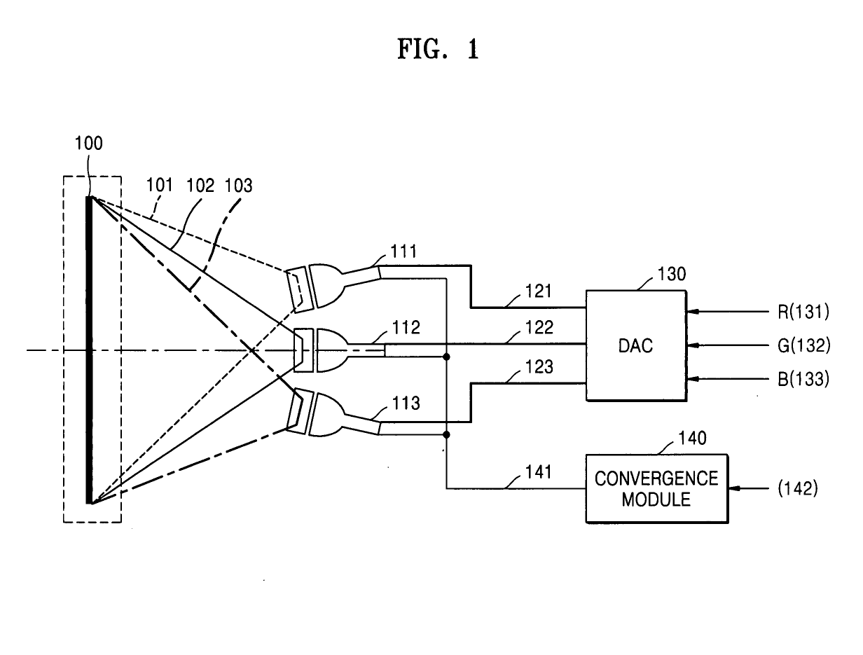

FIG. 2 is a view of a projection device according to the present invention; and

FIG. 3 is a view of a white color CRT according to the present invention.

### DETAILED DESCRIPTION OF THE INVENTION

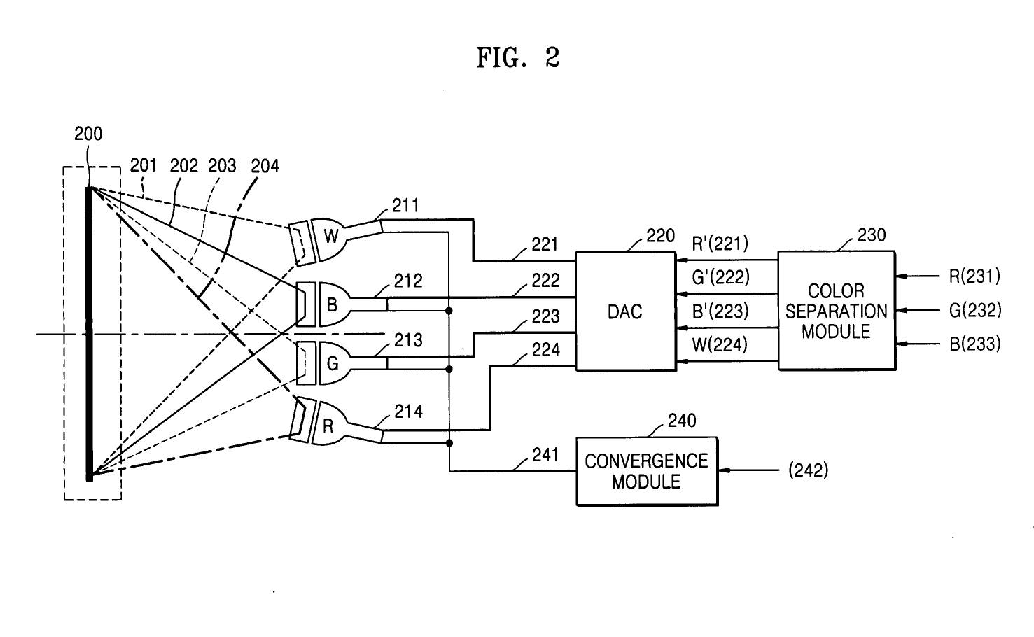

FIG. 2 is a view of a projection device according to the present invention.

The projection device of the present invention includes four cathode ray tubes 211, 212, 213, and 214, a digital-analog converter 220, a color separation module 230, and a convergence module 240.

RGB information 231, 232, and 233 input from an image source (not shown) is converted into R′G′B′W′ information 221, 222, 223, and 224 by a color separation module 230. The R′G′B′W′ information 221, 222, 223, and 224 includes white color information 221 along with the R′G′B′ information. The white color information is formed from the input RGB information 231, 232, and 233. The R′G′B′W′ information 221, 222, 223, and 224 is formed using the following conversion coefficient matrix (C).

$${X}^{′} = X C \\ ∴ [ {R}^{′} {G}^{′} {B}^{′} {W}^{′} ] = [ R G B ] [ \begin{matrix}C11 & C12 & C13 & C14 \\ C21 & C22 & C23 & C24 \\ C31 & C32 & C33 & C34\end{matrix} ] \qquad [ equation 1 ]$$

Here, X′ denotes converted new R′G′B′W′ information, C denotes the conversion coefficient matrix, and X denotes RGB information before conversion.

Coefficients (C11 through C34) of the conversion coefficient matrix can be varied according to the CRT manufacturer or the purpose of use. For example, coefficients C11, C22, and C33 can be set to 1, and C21, C31, C12, C32, C13, and C23 can be set to 0 to calculate a W value while maintaining the RGB values, or adaptive conversion, which selects RGB information according to frame information, can be used. Here, the coefficients should be a value between 0 and 1, and the sum of the coefficients represent one R′G′B′W′ value. For example, since generally W=0.3 R+0.59 G+0.11 B, 0.3+0.59+0.11=1. In the matrix, each of the coefficients should be normalized so that ratios of the components are constant.

The color separation module 230 can be realized by various hardware such as a calculator formed by a logical circuit, a micro-computer, or a filter.

The R′G′B′W information formed by the color separation module is converted into the analog signals 221, 222, 223, and 224 by the digital-analog converter 220, and input into the CRTs 211, 212, 213, and 214.

The CRTs 211, 212, 213, and 214 form optical beams 201, 202, 203, and 204 corresponding to levels of the R′G′B′W information. The optical beams 201, 202, 203, and 204 are concentrated on one point of the screen 200 to form image information of one pixel.

The R′G′B′W information has the same strength ranges as that of the RGB information before conversion, since the sum of the conversion coefficients with respect to the color information is always 1. Here, the strength refers to a relative level of color information. For example, if the RGB information before the conversion process has a strength in a range of 0 to 100 and the conversion coefficients are C14, C24, C34=0.3, 0.59, 0.11, the maximum value of the generated W value is W=0.3 R+0.59 G+0.11 B=0.3×100+0.59×100+0.11×100=100. Thus the value also has the strength in the range of 0 to 100.

However, it should be noted that the strength information of one pixel increases. That is, although the range of the color information is not changed, the number of optical beams projected on one pixel increases, and consequently, one pixel can have the color information within the increased range.

In the case of brightness, the beams having strengths, for example, of R=55, G=87, and B=76 are projected onto one pixel in the conventional art, however, a white color optical beam 211 corresponding to W=0.3×55+0.59×87+0.11×76=76.19 is additionally projected on the pixel in the present invention, thus increasing the brightness.

Also, the contrast function can be improved. Since the maximum brightness increases, the brightness range also increases and the relative difference between the color information of the pixels becomes larger, thus increasing the range of color representation.

For example, the brightness represented as 25 and 55 in the conventional art can be represented as the brightness 16 and 66 according to the present invention, by appropriately selecting the conversion coefficients. In this case, the differences between the brightness values are respectively 30 and 50 in the two cases, thus, the difference in accordance with the present invention becomes larger than that of the conventional art and the contrast increases.

The synchronization signal and information on the pixel position 242 are input from the image source. The information is converted into the convergence control signal 241 by the convergence module 240, and then is input into the CRTs 211, 212, 213, and 214.

The convergence control signal operates coils included in the CRTs, such as a focus coil, a yoke coil, and a deflection coil, and synchronizes the scan of optical beams to coincide at one point.

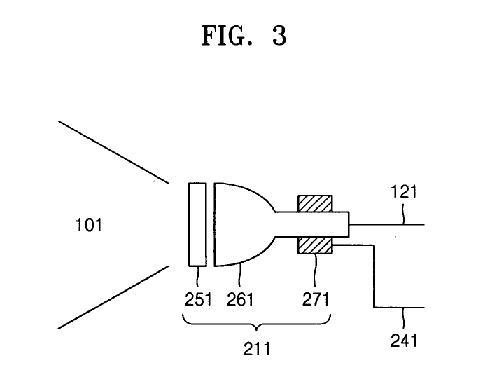

FIG. 3 illustrates the white color CRT according to the present invention.

The white color CRT includes a CRT main body 261 having a beam generation unit and an operation unit like in the red, green, and blue color CRTs, a micro-filter 251, and a convergence circuit unit 271. The CRT main body 261 receives analog signals corresponding to the colors, and generates the optical beams 101 having strengths corresponding to the signals. The optical beam 101 is generated by a beam generation unit, and the optical beams are projected onto various points on the screen by the operation unit. The convergence circuit unit 271 is operated by the convergence control signal 241 received from the convergence module 240, and controls the optical beams generated by the CRT main body 261 to be concentrated on one point of the screen 200.

The micro-filter 251 is a color filter for representing desired color components.

In the white color CRT 211, a white color translucent filter is used. For example, a filter coated by a fluorescent material can be used.

According to the present invention, a four-color projection system including the white color CRT is used to increase the range of color information that one pixel can have, thereby increasing the brightness and contrast characteristics.

Also, according to the present invention, the brightness and contrast characteristics can be improved using the CRT having a smaller aperture, thus solving the heat efficiency problem of a large aperture CRT and the high-costs.

Also, in the present invention, since the conventional red, green, and blue CRTs and the conventional convergence module can be used, it is easy to realize the system of the present invention at a lower cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An image projection apparatus comprising:
a digital-analog converter receiving one or more digital image signals from an image source and converting the digital signals into analog signals;
one or more cathode ray tubes receiving the analog signals and outputting optical beams having respective strengths corresponding to the analog signals;
a screen on which the optical beams are concentrated at a single point to form a pixel; and
a convergence module receiving an image synchronization signal and a convergence control signal from the image source and providing the signals to the cathode ray tubes so that the optical beams can be concentrated at the single point,
wherein the digital image signals include a white color image signal, and the cathode ray tubes include a white color cathode ray tube receiving the white color image signal and outputting a white color optical beam corresponding to the signal.

2. The apparatus of claim 1, wherein the one or more digital image signals include red, green, and blue color image signals which are divided by a red, green, and blue (RGB) color system.

3. The apparatus of claim 2, further comprising a color separation module receiving the red, green, and blue color image signals and generating new red, green, blue, and white color image signals.

4. The apparatus of claim 3, wherein the color separation module generates the new red, green, blue, and white color image signals, R′G′B′W′, using a conversion coefficient matrix C, the conversion coefficient matrix C being defined as X′=XC, wherein, X′ denotes red, green, blue, and white color image signals R′G′B′W′ after conversion, X denotes red, green, and blue image signals RGB before conversion, and C is a 3×4 matrix of
$$[ \begin{matrix}C11 & C12 & C13 & C14 \\ C21 & C22 & C23 & C24 \\ C31 & C32 & C33 & C34\end{matrix} ] .$$

5. The apparatus of claim 4, wherein coefficients C11, C22, C33 equal 1, and coefficients C21, C31, C12, C32, C13, and C23 equal 0 in the conversion coefficient matrix C.

6. The apparatus of claim 4, wherein in the conversion coefficient matrix, C14+C24+C34 equals 1.

7. The apparatus of claim 1, wherein the white color cathode ray tube includes a color filter and a lamp.

8. The apparatus of claim 7, wherein the color filter comprises a translucent white color filter.

9. The apparatus of claim 7, wherein a fluorescent material is applied on the color filter.

10. An image projecting method comprising:
receiving one or more digital signals from an image source and converting the signals into analog signals;
receiving the analog signals and outputting optical beams having strengths corresponding to the analog signals; and
receiving an image synchronization signal and a convergence control signal from the image source and providing the received signals to a cathode ray tube so that the optical beams can be concentrated at a single point,
wherein the digital image signals include a white color image signal, and outputting the optical beams includes receiving the white color image signal and outputting a white color optical beam corresponding to the signal.

11. The projection method of claim 10, wherein the one or more digital signals comprise red, green, and blue image signals which are divided by an RGB color system.

12. The projection method of claim 11, further comprising receiving the red, green, and blue color image signals and generating new red, green, blue, and white color image signals from the received signals.

13. The projection method of claim 12, wherein the color division step generates the new red, green, blue, and white color image signals, R′G′B′W′, using a conversion coefficient matrix C, the conversion coefficient matrix C being defined as X′=XC, wherein, X′ denotes red, green, blue, and white color image signals R′G′B′W′ after conversion, X denotes red, green, and blue image signals, RGB, before conversion, and C is a 3×4 matrix of
$$[ \begin{matrix}C11 & C12 & C13 & C14 \\ C21 & C22 & C23 & C24 \\ C31 & C32 & C33 & C34\end{matrix} ] .$$

14. The projection method of claim 13, wherein coefficients Cl1, C22, C33 equal 1, and coefficients C21, C31, C12, C32, C13, and C23 equal 0 in the conversion coefficient matrix C.

15. The projection method of claim 13, wherein in the conversion coefficient matrix, C14+C24+C34 equals 1.
